(19) United States
(12) Patent Application Publication
(10) Pub. No.: US 2004/0148280 A1
(43) Pub. Date: Jul. 29, 2004

(54) Management information processing method and keyword determination method

(76) Inventor: Moriyuki Chimura, Fremont, CA (US)

Correspondence Address: GRIFFIN & SZIPL, PC, SUITE PH-1, 2300 NINTH STREET, SOUTH, ARLINGTON, VA, 22204, US

(21) Appl. No.: 10/706,289

(22) Filed: Nov. 13, 2003

Related U.S. Application Data
(60) Provisional application No. 60/436,653, filed on Dec. 30, 2002.

(51) Int. Cl. G06F 7/00

(52) U.S. Cl. 707/3

(57) ABSTRACT

A method of processing management information is disclosed that comprises the steps of: receiving electronic information into a receiving server; identifying a sender corresponding to each transmission contained within the received electronic information; determining the number of received transmissions contained within the received electronic information; and performing a first priority ranking of the received electronic information based upon sender criteria and the number of received transmissions. An information processing system for practicing the management information processing method is also disclosed.

This application claims priority on U.S. Provisional Application No. 60/436,653, filed Dec. 20, 2002, the entire disclosure of which is incorporated herein by reference.

### FIELD OF THE INVENTION

The present invention relates to a management information processing method that sorts through such varied, diverse, and vast amounts of public information as may be obtained through the Internet or the like, while screening for selective information with a specific purpose in mind, such as to identify crisis-related information used for generating desired warnings, and carries out a provision (i.e., creates a report) based on the selective information such as will benefit a specific party (i.e., a corporation or the like). The present invention also includes a keyword determination method capable of being used with such management information processing method. The present invention also includes an information processing system that practices the claimed methods.

### BACKGROUND OF THE INVENTION

Contained within information obtainable through the Internet or the like, such as the World Wide Web (hereafter, “WWW”) and/or electronic mail, and so forth (hereinafter collectively referred to as “Internet information”), there is much information that would be useful for corporate management.

However, in order to read voluminous Internet information efficiently, it is desirable to assign priority ranking(s) to information that corresponds to the importance level thereof, and to preferentially read the more important information there among. This feature is desirable because, notwithstanding that important information may be contained and obscured within volumes of information, reading through volumes of information, even with a high speed computer, creates a delay in the time while the information is read, which causes a delay in reaching an appropriate decision. Such reading time delays of the making of an appropriate decision create a risk that considerable damage will occur as a result of the time delay.

As is known in the art of information management, in which priority ranking(s) is or are assigned to information based on previously established keyword(s), and information of high priority level is preferably selected, there are, for example, prior art information management systems such as disclosed in Japanese Patent Application Kokai No. H10-210071 (1998), (hereafter, the “Japanese '071 Application”) and in Japanese Patent Application Kokai No. 2002-99557 (hereafter, the “Japanese '557 Application).

The apparatus and method of the Japanese '071 Application has the object of providing an electronic mail reception notification system capable of automatically determining the priority ranking of, and of displaying, received electronic mail based on keywords established by the recipient of the electronic mail. Specifically, the Japanese '071 Application discloses an electronic mail reception notification system having (a) a data processing device provided with receiving means that receives electronic mail, (b) search means that searches to determine whether previously registered keywords are contained within the electronic mail received, (c) calculation means that calculates a total value of weighted indices for each item of electronic mail received based on keywords, (d) sorting means that carries out a sorting of the electronic mail received in order of a priority ranking in accordance with the calculated total values of weighted indices, (e) a storage device provided with a keyword storage component that stores keywords and keyword weight indices, and (f) an electronic mail storage component that saves received electronic mail sorted in the order of the priority ranking as performed by the sorting means.

In other information management systems, such as the apparatus and method of the Japanese '557 Application, the object is to provide an information providing device, an information providing method, and a recording medium on which an information providing program is recorded. These apparatus, method and recording medium embodiments acquire information required by a user from the World Wide Web (“WWW”), and provide this information to a user without any special operation on part of the user. These prior art systems are characterized by provision of (a) means that automatically peruses information scattered about the Web, (b) means that reads designated Web content by way of an external network, (c) means that automatically stores at the interior of an information providing server device the designated Web content that was read by the reading means, (d) means that carries out an analysis by extraction/categorization/consolidation of information with respect to the stored Web content based on previously established conditions, and (e) at least one of (1) means that automatically distributes analyzed information by way of electronic mail, (2) means that automatically sends analyzed information to a plurality of FAX output devices, or (3) means that automatically prints analyzed information by way of printer(s) or other such printing devices, based on a previously established destination table wherein analyzed data is previously set. Specifically, example 2 of the Japanese '557 Application describes the details of this kind of prior art information management system.

One problem in connection with corporate crisis control is that even where there has been access to critical “facts,” such facts have not been put to their full use or optimal use as management information tools. In order for a particular fact to become managerially useful important information, the information must be available to the right authority in a timely manner. In other words, information is managerially important only when it is made available in a timely fashion to an appropriate departmental organization (i.e., authority) capable of carrying out measures, with respect to certain fact or facts contained within the information, once apprised of such fact or facts. In addition, in order to use volumes of information efficiently, it must be subjected to stringent selection criteria, with priority ranking(s) being assigned thereto and information of high importance level being categorized as having a high priority, whereas less critical information is assigned a lower priority value.

Prior art Japanese '071 Application provides, by virtue of the fact that importance level(s) are determined corresponding to previously established keywords, and electronic mail of high importance level is preferentially read as a result, an information processing system that might be effective if modified and applied to managerial crisis control or the like.

However, the Japanese '071 Application system is limited to notification of receipt of electronic mail, and it imparts neither comment nor suggestion with respect to immediate adoption of appropriate action. In other words, although this system prioritizes email, it does not probe the email for information that would be critical for corporate crisis control. The Japanese '071 Application system, after all, contemplates personal use as its main objective, and is completely devoid of any thought or suggestion of application to corporate strategic use, or similar use, such as for managerial crisis control and so forth.

Furthermore, the organization of the keyword storage component, (i.e., the way in which importance level is decided), is one-dimensional as illustrated in FIG. 5 of the Japanese '071 Application. The assumption limiting the construction of the apparatus and method taught by the Japanese '071 Application is that the destination of output is such that the data processing device receiving means is the recipient receiving the output. The apparatus and method disclosed by the Japanese '071 Application do not contemplate complex circumstances of use, such as is the case where a multiplicity of electronic mail items must be sorted corresponding to importance level, then distributed to a plurality of addresses (i.e., prescribed departmental organizations/authorities and/or the like) with instructions appended thereto directing that an appropriate response should be taken, and so forth.

The prior art Japanese '557 Application discloses an information providing server device that peruses the WWW and acquires information, wherein keywords are used as keys for categorizing/abstracting content, which is then sent by means of electronic mail, FAX, or the like, to prescribed departmental organizations/authorities, and/or the like. In the device disclosed by Japanese '557 Application, abstracting as used in this reference is nothing more than what is provided by the URL and the leading 100 characters, not including reserved words and/or control commands of the information read therein, etc. There is nothing provided by the device disclosed by the Japanese '557 Application imparting comment along with the information such as would immediately solicit appropriate action from the proper managerial authority. In fact, the device disclosed by the Japanese '557 Application requires that the user who is receiving the information must first read the leading 100 characters of the content of the categorized/abstracted information, which is listed on the electronic mail, FAX, or the like. Where necessary, the user must access the listed URL and confirm its content, following which the user must determine for himself the action to be taken. In other words, the device disclosed by the Japanese '557 Application categorizes or abstracts information, but it does not teach, or even suggest, screening the information for critical facts and analyzing the facts to direct a user to an appropriate response.

Furthermore, there is an additional problem in that when the source of information obtained as a result of perusal of the WWW states non-factual information, such as opinion or commentary, the URL will be selected so long as there is a keyword match, regardless of whether the reliability of the factual content of the information may be low. Moreover, among conventional managerial information processing systems, there does not exist a system that automatically creates comments with respect to keywords and creates reports used in decision-making.

Consequently, it is an object of the present invention to provide a management information processing method that selects only information that will benefit a specific user. Such beneficial information must be highly reliable so that it is useful to corporate management, or the like, and the beneficial information must be selected from among varied, diverse, and vast amounts of electronic information obtainable via the Internet, or the like. Lastly, the selected information must be processed and analyzed so that it gives immediate instruction to a user as to what appropriate response is required, and the management information processing method in accordance with the present invention is compatible with a keyword determination method capable of being used with this information processing method.

### SUMMARY OF THE INVENTION

In order to achieve the foregoing objects, a first management information processing method embodiment in accordance with the present invention is provided, in the context of a system wherein receiving server(s) which receive electronic information originating from a plurality of sender(s) (80a, . . . , 80n) select specific information included within the electronic information, create report(s) containing comment(s) soliciting action(s) corresponding to the content of the specific information selected, and that send the selected specific information to previously established destination(s), wherein the method is characterized by the steps comprising:

a. step(s) wherein electronic information is received by the receiving server(s);

b. step(s) wherein sender(s) of the electronic information is, or are, determined by the receiving server(s);

c. step(s) wherein number(s) of received transmissions deemed to have been received from the same one or more of that or those sender(s) is or are determined by the receiving server(s);

d. step(s) wherein first priority ranking(s) is or are decided by the receiving server(s) based on number(s) of transmissions received from the sender(s);

e. search step(s) wherein group(s) of keyword(s) previously assigned information-related importance level(s) is or are used in searching by the receiving server(s) for keyword(s) contained within information received at the receiving step(s);

f. step(s) wherein second priority ranking(s) is or are decided by the receiving server(s) based on importance level(s) assigned to keyword(s) extracted as a result of the search of the received information;

g. step(s) wherein comment(s) is or are created by the receiving server(s) based on the first and second priority ranking(s);

h. step(s) wherein report(s) comprising sender(s), number(s) of transmissions received, and comment(s) is or are created by the receiving server(s).

The management information processing method of the first embodiment described above makes it possible to exclude unwanted information contained within varied, diverse, and vast amounts of electronic information, to efficiently accept important information as well as measures in response thereto, and permits efficient information confirmation, reviewing, and reporting/communicating of the information and so forth, thereby making it possible to avoid managerial opportunity losses due to missed information and/or delays in confirmation of important information.

In addition, the first method embodiment may be modified such that, at the aforementioned step(s) e, the group(s) of keyword(s) comprise shared keyword(s) indicating universal item(s) and individual keyword(s) indicating individual item(s), and the comment(s) comprise first comment(s) previously established to correspond to shared keyword(s) and second comment(s) previously established to correspond to individual keyword(s).

Such division of shared keywords and individual keywords makes it possible to achieve maintenance/improvement of system quality, and moreover permits achievement of improved efficiency with respect to time required for verification and/or comparison with received information (i.e., received data). Moreover, improvement in efficiency with respect to development of keyword databases is permitted.

Furthermore, such methods in accordance with the embodiments described above may be further provided with step(s) wherein a portion of keyword data contained within database(s) in which individual keyword(s) is, or are, saved is moved to database(s) in which shared keyword(s) is, or are, saved.

By moving saved portions of keyword data, it is possible to achieve maintenance/improvement of shared keyword quality, which will in turn make it possible to achieve maintenance/improvement of system quality.

At the aforementioned step(s), during verification and/or comparison between received information and keyword database(s), investigation may be first carried out to ascertain whether keyword(s) which is or are the same as keyword(s) saved in shared database(s) is or are present in received information, following which investigation may be carried out to ascertain whether keyword(s) which is or are the same as keyword(s) saved in individual keyword database(s) is or are present.

By carrying out the above-described investigation steps, it is possible to carry out verification and comparison of received information with important keywords more efficiently. Furthermore, dividing database(s) into two types makes it possible to reduce database access time.

A keyword determination method embodiment is provided in accordance with the present invention wherein there is provided a method for determining whether received information comprises word(s) which is or are the same as keyword(s) registered within any of keyword database(s) 32 groups so as to be numbered from a 1st through an nth (where n is a natural number), and is characterized in that it comprises step(s) wherein word(s) making up text contained within received information is or are sequentially compared with keyword(s) belonging to the keyword database 32 group(s); and step(s) wherein, in the event that there is or are matching word(s), Y flag(s) is or are set and that or those word(s) is or are saved in extracted keyword database 34, and in the event that there is no match, N flag(s) is or are set, with nothing being saved in extracted keyword database 34.

In a third method embodiment in accordance with the present invention, a method of processing management information is provided that comprises the steps of: (a) receiving electronic information into a receiving server; (b) identifying a sender corresponding to each transmission contained within the received electronic information; (c) determining the number of received transmissions contained within the received electronic information; and (d) performing a first priority ranking of the received electronic information based upon sender criteria and the number of received transmissions.

In a fourth method embodiment in accordance with the present invention, the third embodiment is modified so that the received electronic information is checked for one or more computer viruses when received into the server.

In a fifth method embodiment in accordance with the present invention, the third embodiment is further modified to include the steps of: (e) performing a keyword search on the received electronic information, wherein the keyword search includes comparing a first keyword stored in a keyword database to each word in the received electronic information and setting a Y flag when there is a match and setting a N flag when there is no match.

In a sixth method embodiment in accordance with the present invention, the fifth method embodiment is further modified so that each time the Y flag is set, the word matching the keyword is saved in an extracted keyword database.

In a seventh method embodiment in accordance with the present invention, the sixth method embodiment is further modified to include the steps of: (f) performing a second priority ranking of the received electronic information based upon one or more extracted keywords; and (g) performing a final priority ranking of the received electronic information based upon a matrix calculation utilizing the first priority ranking and the second priority ranking.

In an eighth method embodiment in accordance with the present invention, the seventh embodiment is further modified to include the step of: (h) generating one or more comments corresponding to the one or more previously extracted keywords and the final priority ranking and attaching these one or more comments to the received electronic information.

In a ninth method embodiment in accordance with the present invention, the eighth method embodiment is further modified to include the step of: (i) organizing the first priority ranking, the second priority ranking, the extracted keywords, the number of received transmissions, the one or more comments, and the received electronic information into a report format, then sending one or more reports to a predetermined destination.

In a first apparatus embodiment in accordance with the present invention, an information processing system is provided that is connected to receive electronic information, wherein the system includes at least one receiving server, and the at least one receiving server comprises: (a) a signal receiving component connected to receive the electronic information, wherein the receiving component determines a first priority ranking of the received electronic information; (b) a keyword analyzing component connected to receive the first priority ranked electronic information and the received electronic information from the receiving component, wherein the keyword analyzing component performs a keyword search of the received electronic information and determines a second priority ranking of the received electronic information based on keywords extracted from the received electronic information; (c) a comment component connected to receive the second priority ranked electronic information and the received electronic information from the keyword analyzing component, wherein the comment component calculates a final priority ranking and generates one or more comments based upon the final priority ranking; and (d) a report component connected to receive the received electronic information, the final priority ranked information and the one or more generated comments, wherein the report component generates one or more reports incorporating the received electronic information, the final priority ranked information, and the one or more generated comments.

In accordance with a second apparatus embodiment of the present invention, the first apparatus embodiment is modified so that the system is connected to receive electronic information from either the Internet or a computer network system.

In accordance with a third apparatus embodiment of the present invention, the first apparatus embodiment is modified so that the signal receiving component comprises: (i) a virus checking component that checks the received electronic information for one or more computer viruses; (ii) a sender determining component connected to receive the received electronic information from the virus checking component, wherein the sender determining component determines the identity of the sender of the received electronic information; and (iii) a transmissions determining component connected to receive the received electronic information from the virus checking component, wherein the transmissions determining component determines the number of transmissions received from each sender.

In accordance with a fourth apparatus embodiment of the present invention, the first apparatus embodiment is modified so that the signal receiving component comprises: (i) a sender determining component connected to receive the received electronic information, wherein the sender determining component determines the identity of the sender of the received electronic information; and (ii) a transmissions determining component connected to receive the received electronic information, wherein the transmissions determining component determines the number of transmissions received from each sender.

In accordance with a fifth apparatus embodiment of the present invention, the fourth apparatus embodiment is further modified so that the signal receiving component further comprises a priority ranking component connected to receive input from both the sender determining component and the transmission determining component, wherein the priority ranking component performs the first priority ranking of the received electronic information by utilizing both the identity of and the corresponding number of transmissions received by each sender.

In accordance with a sixth apparatus embodiment of the present invention, the first apparatus embodiment is modified so that the keyword analyzing component comprises a keyword determining component connected to access one or more keyword databases and connected to send output to at least one keyword extracting database, wherein the keyword determining component compares individual words from the received electronic information to each keyword stored in the one or more keyword databases and determines when there is a match so that when there is a match the keyword determining component sets a Y flag and the matched word is saved in the at least one keyword extracting database.

In accordance with a seventh apparatus embodiment of the present invention, the first apparatus embodiment is modified so that the comment component comprises a priority ranking determination/comment attachment component that includes a plurality of calculating components and a sorting component, wherein the priority ranking component utilizes the first priority ranking and the second priority ranking to calculate a matrix and assigns the final priority ranking based upon the relative magnitudes of each matrix element.

In accordance with an eighth apparatus embodiment of the present invention, the first apparatus embodiment is modified so that the report component organizes the first priority ranking, the second priority ranking, the extracted keywords, the number of received transmissions, the one or more comments, and the received electronic information into a report format, then sends one or more reports to a predetermined destination.

Further objects, features and advantages of the present invention will become apparent from the detailed description of preferred embodiments, which follows, when considered together with the attached drawings.

### BRIEF DESCRIPTION OF DRAWINGS

FIG. 1 schematically illustrates a working example of a management information processing method in accordance with the present invention.

FIG. 2 is a flow diagram showing the processing steps in a management information processing method in accordance with the present invention.

FIG. 3 (a) is a block diagram of the entirety of a system capable of being used with a management information processing device according to the present invention, and FIG. 3 (b) is a keyword composition table corresponding to an example of keyword priority ranking B (i.e., second priority ranking).

FIG. 4 is a schematic block diagram showing the structure of the interior of signal receiving component 20.

FIG. 5 is a schematic block diagram showing the structure of the interior of keyword analyzing component 30.

FIG. 6 is a flow diagram showing an example of a flowchart of a program for executing a keyword determination system in accordance with the present invention.

FIG. 7 includes a portion thereof indicated by the broken line that illustrates an example of a block diagram showing the interior of priority ranking determination/comment attachment component 40.

### DESCRIPTION OF REFERENCE NUMERALS

10 Receiving server

20 Signal receiving component

21 Virus checking component

22 Sender determining component

23 Number of received transmissions determining component

24 Priority ranking determining component (first priority ranking component)

25 Database

30 Keyword analyzing component

31 Keyword determining component

32 Keyword database

33 Keyword designating system

34 Extracted keyword database

40 Priority ranking determination/comment attachment component

41a-41c Calculating component(s)

42 Sorting component

50 Report component (also called the “output means”)

60 Internet

80a-80n Terminal device(s)

90 Information server

### DESCRIPTION OF THE ILLUSTRATIVE EMBODIMENTS

The illustrative embodiments in accordance with the invention are described below, with reference to the figures in which like elements are indicated with like reference numerals. To facilitate an easy understanding of the present invention, the system apparatus embodiment will be described first, then the method embodiment will be described second.

The Overall System

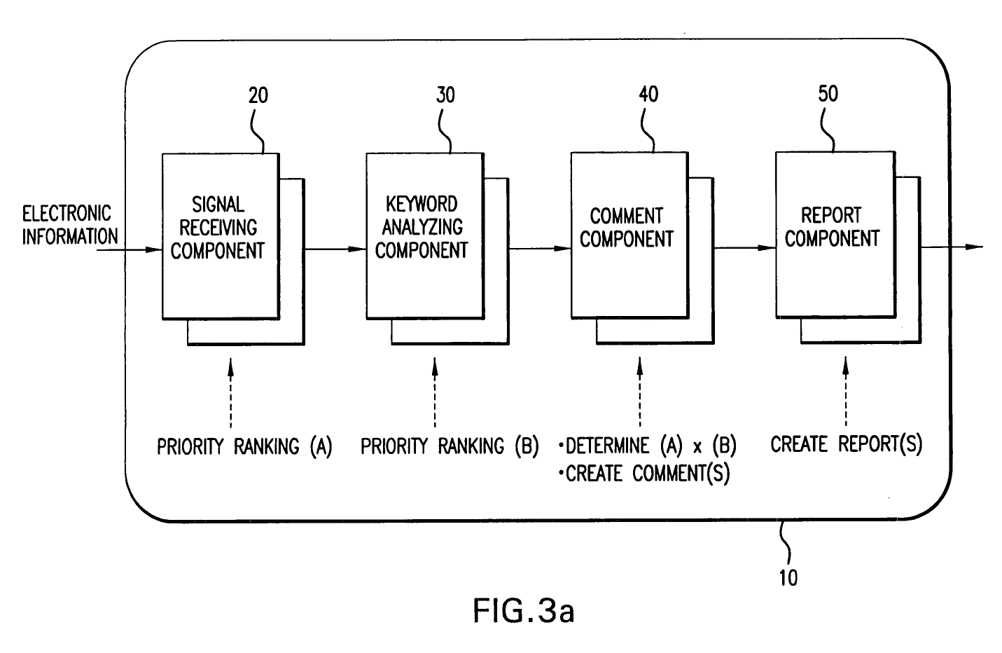

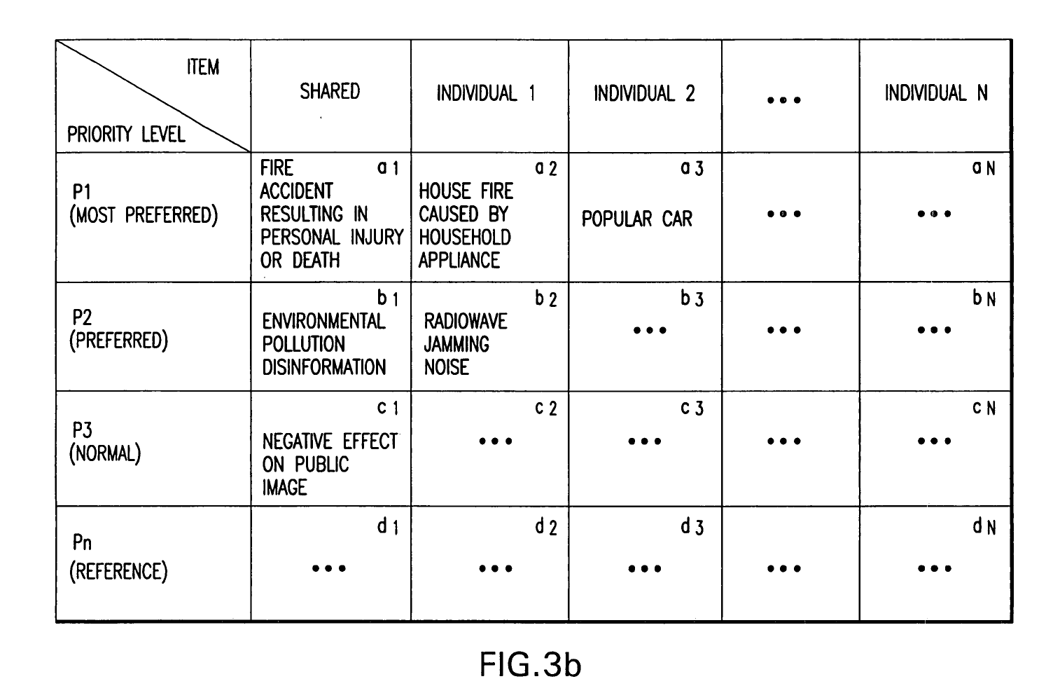

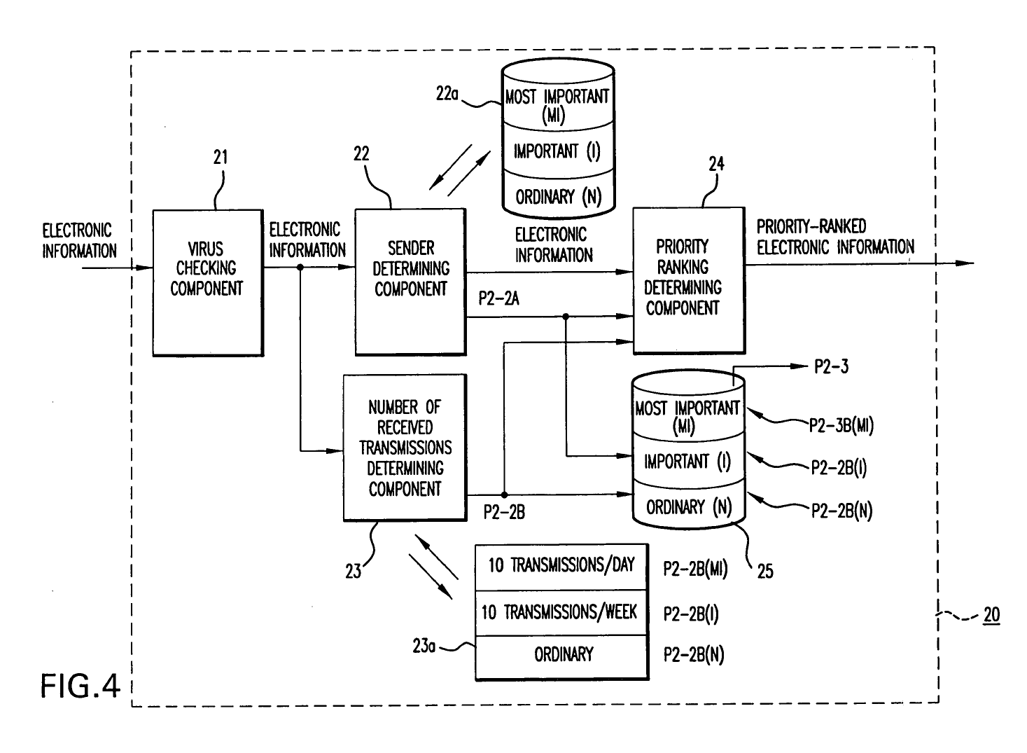

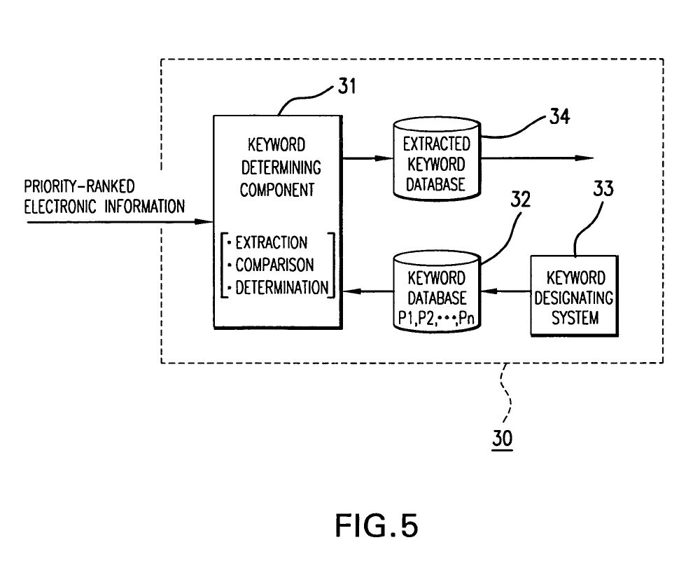

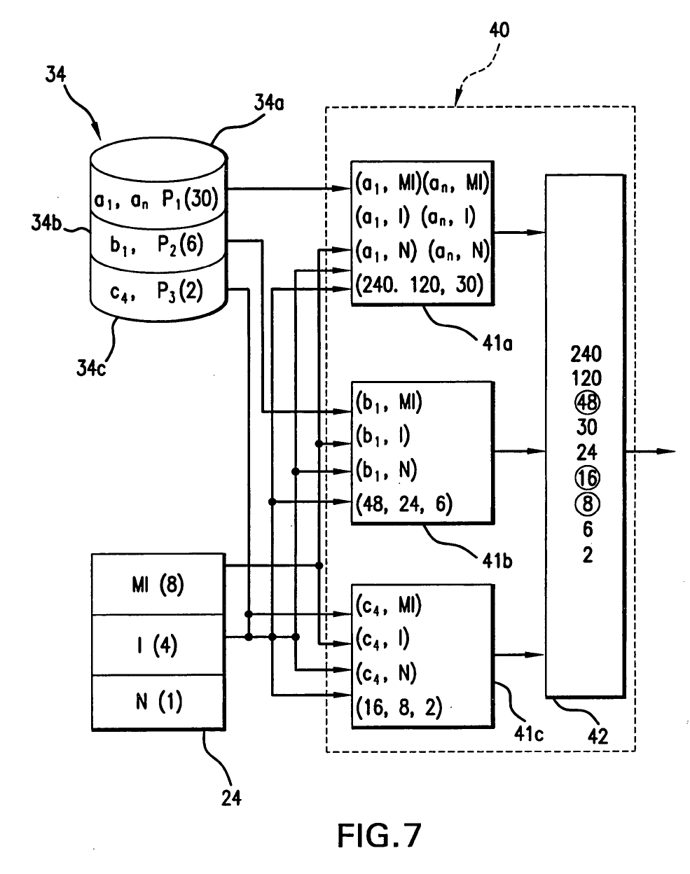

FIG. 3 (a) is a schematic block diagram describing a management information processing system in accordance with the present invention. This system is housed within receiving server(s) (see FIG. 3a) and comprises signal receiving component(s) 20 (see FIG. 4), which receive electronic mail or other such electronic information; keyword analyzing component(s) 30 (see FIG. 5); priority ranking determination/comment attachment component(s) 40 (see FIG. 7); and report component(s) (also referred to as “output means”) 50 (see FIG. 3a).

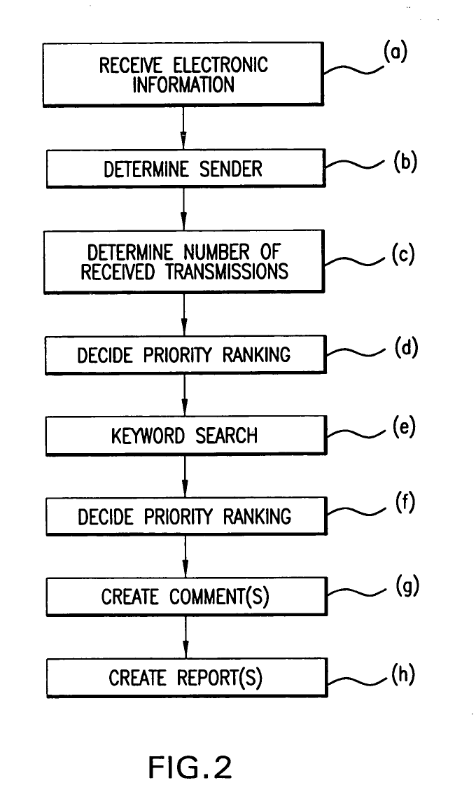

Signal receiving component 20 carries out discrimination with respect to sender (e.g., for a customer or the like), determines the of number of received transmissions, and assigns weights to the information, then attaches a priority ranking A (also referred to as the “first priority ranking”) pursuant to the number of received transmissions and outputs priority-ranked electronic information. In other words, the signal receiving component 20 outputs first priority-ranked electronic information by weighing and ranking transmissions on the basis of sender criteria, and also transmits the received electronic information. Signal receiving component 20 performs steps (a)-(d) shown in the method outlined in FIG. 2.

Keyword analyzing component 30 receives the first priority-ranked electronic information and the received electronic information outputted from the signal receiving component 20 and attaches priority ranking B by extracting keywords contained within the received electronic information that has passed through the signal receiving component 20 in accordance with previously registered keyword priority ranking B (also referred to as the “second priority ranking”). In this manner, keyword extracting component 30 receives the received electronic information and outputs second-priority ranked electronic information by extracting keywords and assigning priority on the basis of the weights associated with each keyword. Keyword extracting component 30 also transmits the first priority ranked electronic information along with the received electronic information. Keyword extracting component 30 performs a portion of step (f) of the method outlined in FIG. 2.

Priority ranking determination/comment attachment component 40 receives the second-priority ranked electronic information outputted by the keyword extracting component 30 in addition to the first priority ranked electronic information and the received electronic information, and subsequently carries out a final priority ranking of the received signal based on the result of the analysis performed by keyword analyzing component 30 and the result of the determination of the number of received transmissions detected by the signal receiving component 20, then attaches one or more comments corresponding to the keyword(s) previously extracted and the first and second or the final priority ranking(s), and sends final priority ranking(s) and the keyword(s) and the one or more comments to report component 50. In other words, priority ranking determination/comment attachment component 40 receives the second-priority ranked electronic information then creates final-priority ranked electronic information on the basis of the keyword analysis performed by keyword analyzing component 30 and the number of transmissions detected by signal receiving component 20 that was used to perform the first priority ranking information, then attaches one or more comments. Lastly, the priority ranking determination/comment attachment component 40 sends the final-priority ranked electronic information with the attached one or more comments along with the keyword(s) as output to the report component 50. priority ranking determination/comment attachment component 40 also transmits the received electronic information. Priority ranking determination/comment attachment component 40 performs step (g) of the method outlined in FIG. 2.

At report component 50, one or more reports are created or generated based on information contained in the output sent from comment attachment component 40. Each one of the one or more reports are created and dispatched respectively so as to be suitable for top management, customers, and/or other such previously established destination(s). Note that, as used in the present specification, the report component 50 is used in a broad sense to include terminals or the like for displaying the results of the creation of reports, and/or other such output means for displaying reports. Although not limited to these particular output means, several examples of devices for displaying reports include computer terminal displays, printers, facsimile machines, telemonitors and the like. The report component 50 in accordance with the present invention performs step (h) and a portion of step (f) of the method outlined in FIG. 2.

Described in detail below for each block component (i.e., 10, 20, 30, 40) is the structural constitution of each component and the flow of information processing steps corresponding to each component.

Signal Receiving Component

Signal receiving component 20 operates as follows: (a) it receives electronic mail or other such electronic information, (b) determines whether such electronic information is information that should be received, and (c) also determines whether or not electronic information is from a known sender or a new sender. Moreover, signal receiving component 20 also carries out assignment of importance level for known senders. Exemplary structural configurations for the signal receiving component 20 are described below.

FIG. 4 is a block diagram showing the structural interior of signal receiving component 20. In the present example, the signal receiving component 20 is provided with a three-stage structure that includes: (1) virus checking component(s) 21, (2) one or more sender determining components 22, one or more “number of received transmissions” determining components 23, and one or more priority ranking determining components 24 for performing the first priority ranking, and (3) one or more databases 25.

With this structure, unprocessed electronic information sent from a www browser, electronic mail, and/or the like, is first sent to virus checking component 21, where a first investigation is carried out to determine whether the electronic information received contains any computer virus(es) or not. Electronic mail or the like which does contain computer virus(es) is either deleted, or the virus(es) are removed therefrom using an anti-virus program incorporated into the virus checking component 21.

Note that while the present invention can be practiced without the virus checking component 21, in light of the fact that this feature permits before-the-fact prevention of system failure and the like due to computer viruses, it is preferable to provide a virus checking component 21 especially at the front stage of the signal receiving component.

Unprocessed electronic information that has passed through virus checking component 21, and has been confirmed to be safe (i.e., virus free), is sent to sender determining component 22 and to the “number of received transmissions” determining component 23. At sender determining component 22, sender information included within the received electronic information is used to identify one or more sender names. More specifically, for example, where the source of the electronic information is electronic mail, the sender may be identified by investigating to determine the domain name, and so forth, of the sender's electronic mail address.

Sender determining component 22 operates to classify the sender of the received electronic information based on information stored in one or more sender databases 22a, which classifies each known sender according to importance level and attaches first priority information, such as assigning unit P2-2A for example, to the electronic information.

Importance level is assigned to each sender in accordance with a sender priority ranking that is programmed into the sender data within sender database 22a. For example, importance level can be categorized by dividing senders into a most important (MI) group, an important (I) group, and an others (N) group, wherein different priority scores are assigned to the respective groups (e.g., MI=8, I=4, N=1). The number of sender importance level groups is not limited to three exemplary ranking groups, there being freedom to more finely divide sender priority rankings so that sender importance level can be subdivided four or more ways without departing from the spirit of the present invention.

The “number of received transmissions” determining component 23, on the other hand, determines the frequency, or frequencies, with which electronic transmissions have been received in accordance with frequency determinative criteria from one or more guidelines 23a for determining the number of received transmissions. The one or more guidelines 23a for determining the number of received transmissions are categorized by frequency with which transmissions are received from each sender. This feature permits the carrying out of assignment of priority ranking (which is an assignment of weight) so as to give preference to information from senders whose electronic information is received more frequently, and permits the output of second priority information, such as assigning unit P2-2B to this output for example, which is then sent to the next stage of information processing (i.e., priority ranking determining component 24 and database 25).

For example, the frequency determinative criteria may be prepared so that 10 or more received transmissions per day is ranked most important (MI), 10 or more received transmissions per week is ranked important (I), and anything less than that is ranked normal (N) priority.

Input received by priority ranking determining component 24 includes electronic information that has passed through sender determining component 22, and that incorporates first and second priority information, such as assigning units P2-2A and P2-2B, respectively, which have been output from sender determining component 22 and “number of received transmissions” determining component 23, and output therefrom is priority-A-ranked (i.e., first-priority-ranked) electronic information. The results of this first-priority-ranked electronic output are sent to keyword analyzing component 30, which performs the next stage or step in the information processing method.

Furthermore, it is desirable that a database 25, having a memory capable of saving additional data is provided so that the additional saved data, (e.g. priority-A-ranked electronic information) is categorized and saved by priority ranking. In this manner, first and second priority information, such as assigning units P2-2A and P2-2B, previously obtained from sender determining component 22 and “number of received transmissions” determining component 23, can be saved in the memory of database 25.

While the present invention can be practiced without database 25, it is preferable to practice the present invention with such a memorizing database because providing at least one database 25 permits the effective utilization of priority ranked electronic information saved to database 25 at one or more later stages of information processing (i.e., processing performed by keyword analyzing component 30 and/or the like), or by other information processing systems.

Keyword Analyzing Component

FIG. 5 is a block diagram showing the interior of keyword analyzing component 30. The keyword analyzing component 30 comprises one or more keyword determining components 31, one or more keyword databases 32, one or more keyword designating systems 33, and one or more extracted keyword databases 34.

Keyword database 32 is provided with one or more storage devices, (i.e., memory), that store previously prepared keywords organized according to priority ranking. Furthermore, keyword designating system 33 is provided with the ability to designate keywords, categorized according to topic and according to purpose, as one or more keyword database groups to be selected in advance by keyword database 32, depending on the sender and on sent content (i.e., the content of the email and the like). Extracted keyword database 34 is provided with one or more storage devices, (i.e., memory or the like) that store keywords extracted from received signals.

Note that for the one or more keyword databases, priority ranking is assigned at the group level so there is no priority ranking within the same group(s). In other words, priority ranking is assigned to groups of keywords having the same priority ranking rather than assigning each keyword an individual priority ranking. This priority ranking scheme is chosen not because priority ranking is assigned with the object of time efficiency in mind with respect to searching of keywords from received information, but because the goal of the priority ranking scheme is for extracting keywords having important content from received information. With respect to this object, the present embodiment in accordance with the invention is different from the organization of the keyword database disclosed by the Japanese '557 Application, which arranges priority ranking into different categories in order to reduce keyword search time.

Priority-ranked (A) electronic information along with the received electronic information, which is output from the previous stage of information processing provided by signal receiving component 20, is first input received at keyword determining component 31. Here, keyword extraction, comparison, determination, and/or the like takes place. More specifically, keyword extraction is carried out with respect to the received signal (i.e., the received electronic information), comparison is made with previously prepared keywords, and determination is performed to see whether one or more identical keywords are present.

The keyword determination process is performed by the keyword analyzing component 30, which operates to receive electronic information and to first separate it into individual words, then keywords contained within the electronic information are extracted as a result of a comparison between the respective separated words and the keywords registered in the respective keyword groups. The matched word results of this keyword extraction process are saved in extracted keyword database 34, and additional keyword databases are sequentially utilized in the keyword determination process by carrying out the steps of separating individual words and extracting keywords by comparing individual words to the keywords in repetitive fashion until the remaining keyword databases have been utilized.

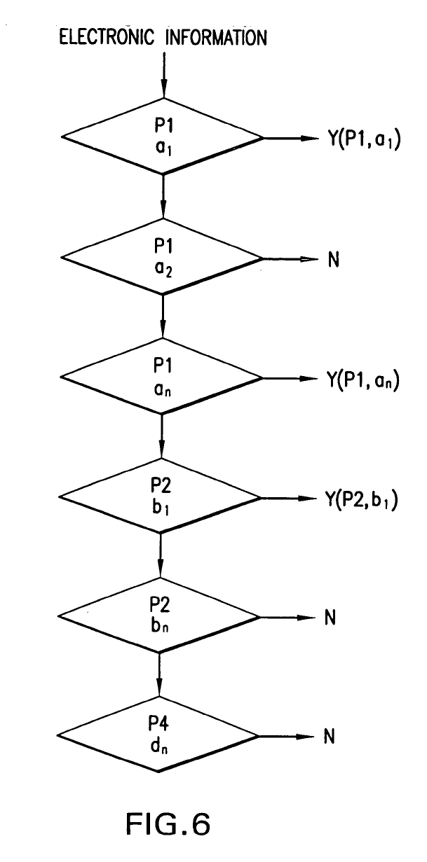

FIG. 6 illustrates a flowchart of an exemplary method (i.e., program or algorithm) for executing operation of a keyword determination system. First, received electronic information is compared with a keyword “a1” in a most important keyword group “P1” in the keyword database 32, which is categorized according to priority ranking. In other words, keyword “a1” in keyword group “P1” has a specific priority ranking in keyword database 32.

During this first step of keyword comparison, if there is or are one or more matching words matching the keyword “a1,” then the Y(P1, a1) flag is set, but if no matching word exists then the N(P1, a1) flag is set instead. In addition, after setting the Y or N flag, the received electronic information is sent to the second step, which is next.

It is noted that when the Y flag is set, the one or more matching words is or are saved to extracted keyword database 34; however, when the N flag is set, there are no matching words so there are no matches to save.

Thus, the keyword determination process of the present system is characterized by determining the presence or absence of one or more specific keywords that have been previously registered from among unspecified text (i.e., whatever keywords are considered desirable by corporate management).

At the respective steps in the flowchart of FIG. 6, when the corresponding keyword(s) is or are contained within received electronic information, by respectively setting Y and N flags corresponding to those keywords and saving the flagged matches in one or more databases, postprocessing is made possible wherein only specific keyword(s) for which corresponding Y and N flags are set or are collected.

In the example shown at FIG. 6, because one or more words contained in the received electronic information match keyword “a1” of keyword group “P1,”, the Y(P1, a1) flag is set and these matched word or words are saved to extracted keyword database 34.

Received electronic information sent to the second step is compared with the next keyword “a2,” and if there is a match then the Y flag is set, but if there is no match then the N flag is set. As described above, when the Y(P2, a2) flag is set, then the one or more matched words corresponding to keyword “a2” of keyword group “P1” are saved to extracted keyword database 34. The third step is a reiterative step wherein all of the remaining “n-2” keywords, which are the keywords “a3 . . . aₙ” of keyword group P1, are compared with the individual separated words contained in the received electronic information, and when there is one or more matching words, the corresponding Y flag is set for that particular keyword and the one or more matched words are saved to the extracted keyword database 34 in a manner so as to correspond to the appropriate keyword. Once all of the keywords “a1 . . . aₙ” of keyword group P1 have been extracted from the received electronic information and saved in the extracted keyword database 34, the received information is sent to the next step, which is the fourth step.

In the particular example shown at FIG. 6, because none of the words contained in the received information match keyword “a2” of keyword group “P1,” the N(P1, a2) flag is set during the second step and no words corresponding to the “a2” keyword are saved in the extracted keyword database 34. Subsequently, the received electronic information is sent to the next step, which is the third step before being sent to the fourth step.

In this manner, received electronic information is sequentially sent to one or more subsequent sub-steps of reiterative step three so that the received electronic information is compared with each of the remaining keywords “a3” to “aₙ,” wherein “aₙ” is the Nth, or last keyword aₙ, of the most preferred keyword group P1. Moreover, if there are one or more matching word(s) corresponding to the keyword “aₙ,” then the Y(P1, aₙ) flag is set and those one or more matching words are saved to extracted keyword database 34. If no matching word exists corresponding to the “aₙ” keyword, then the N(P1, aₙ) flag is set, no matching words corresponding to the “aₙ” keyword were found, and the received electronic information is sent to the fourth step, with nothing being saved to extracted keyword database 34 that would correspond to a match with the “aₙ” keyword.

In summary, steps 1-3 correspond to extracting keywords “a1 . . . aₙ” of the “P1” keyword group from the received electronic information, such as an email.

The next steps carry out a similar routine with respect to the preferred keyword group “P2.” In this case, keyword group “P2” contains “N” keywords, whereas keyword group “P1” contained “n” keywords. Those skilled in the art would realize that either n=N, or n≠N, without departing from the spirit and scope of the present invention.

So, in a like manner as in steps 1-3, the received electronic information is compared in the fourth step with keyword “b1” of the preferred keyword group “P2.” During the fourth step, if there are one or more words matching keyword “b1” then the Y(P2, b1) flag is set, but if no matching word exists in the received information then the N(P2, b1) flag is set. When the Y(P2, b1) flag is set, the one or more matched words are saved in extracted keyword database 34. On the other hand, when the N(P2, b1) flag is set, there are no matches for the “b1” keyword so there are no matched words to save to the extracted keyword database 34. In addition, after setting the Y or N flag in the fourth step, the received information is sent to the next step, which is the fifth step.

Those skilled in the art will appreciate that whenever the Y flag is set, the one or more matching words are saved to extracted keyword database 34; however, whenever the N flag is set, there are no words in the received electronic information that match the corresponding keyword, so there would be no extracted words to save.

Once the fourth step is completed, the received information is sent to the next step, which is the fifth step, wherein the received information is compared with the next keyword “b2” of the “P2” keyword group. If there is at least one word match then the Y flag is used and one or more matched words are saved to the extracted keyword database 34, but if there is no match, then the N flag is used. The fifth step is a reiterative step wherein all of the remaining “N” keywords, “b2 . . . b_{N},” are compared with the individual separated words contained in the received electronic information. As described above for step 3, when there is one or more matching words, the corresponding Y flag is set for the particular keyword and the one or more matched words are saved to extracted keyword database 34. Once the fifth step is complete, the received information is sent to the next step, which is the sixth step.

In this manner, received information is sequentially sent to subsequent sub-step(s) of the fifth step, until the received information is compared with the Nth, or last keyword b_{N}, of the preferred keyword group “P2.” Moreover, if there are one or more matching words, then the Y(P2, b_{N}) flag is set and the matching words are saved to extracted keyword database 34. If no matching word exists, then the N(P2, b_{N}) flag is set and the received information is sent to the next step, there being no matching words to save to extracted keyword database 34.

At the next steps, a similar routine is carried out with respect to the next keyword group “P3.” In other words, the received electronic information is compared with keyword “c1” of the normal keyword group “P3.” During this sixth step, if there are one or more matching words that match keyword “c1” then the Y(P3, c1) flag is set, but if no matching word exists then the N(P3, c1) flag is set. In addition, after setting the Y or N flag, received information is sent to the next sub-step of the sixth step.

When the Y flag is set, that or those word(s) is or are saved to extracted keyword database 34; however, when the N flag is set, there are no matched words to save.

The received information sent to the next sub-step of step sixth is compared with the next keyword “c2,” and so on, and if there is a match then the Y flag is used, but if there is no match then the N flag is used, then the received information is sent to the next sub-step of step six.

In this manner, the received information is sequentially sent to subsequent sub-steps of the sixth step until it is compared with the Mth, or last keyword c_{M} of the normal keyword group P3. Moreover, if there are one or more matching words that match keyword “c_{M},” then the Y(P3, c_{M}) flag is set and those words are saved to extracted keyword database 34. If no matching word exists, then the N(P3, c_{M}) flag is set before sending the received information to the next step, which is the seventh step, with no words matching the “c_{M}” keyword being saved to the extracted keyword database 34.

Those skilled in the art would recognize that the sixth step is performed in the same manner as the fifth step, except that the keywords compared to the received electronic information are those of the “P3” normal keyword group. The “P3” keyword group would have “M” keywords, “c1 . . . c_{M},” wherein M may or may not be equal to N and/or n.

At the next steps, which is the seventh step, a similar routine is carried out with respect to reference keyword group “P4.” In the seventh step the received information is first compared with keyword “d1” in reference keyword group “P4.” During this step, if there are one or more matching words that match keyword group “P4,” then the Y(P4, d1) flag is set; however, if no matching word exists then the N(P4, d1) flag is set. In addition, after setting the Y or N flag, the received information is sent to the next sub-step of the seventh step.

When the Y flag is set, the corresponding matched words are saved to the extracted keyword database 34; however, when the N flag is set, there are no matched words to save.

The received electronic information is sent to the next sub-step of the seventh step and is compared with the next keyword “d2.” If there is a match, then the Y flag is used, but if there is no match then N is used as flag. In accordance with the present invention, the received information is sent to the next sub-step of the seventh step.

In this manner, the received information is sequentially sent to subsequent sub-steps of the seventh step until the information is compared with the Nth, or last keyword d_{N}, of the reference keyword group “P4.” Moreover, if there are one or more matching words, then the Y(P4, d_{N}) flag is set and the one or more matching words are saved to the extracted keyword database 34 and the keyword search processing corresponding to step (e) in FIG. 2 terminates. On the other hand, if no matching words exist, then the N(P4, d_{N}) flag is set and the keyword search processing, corresponding to step (e) in FIG. 2, terminates with no matched words corresponding to the “d_{N}” keyword saved to extracted keyword database 34. Those skilled in the art would realize that “N” in this context could be any integer number. In other words, the various keyword groups “P1, P2, P3, . . . P_{N}” could have the same number or different numbers of keywords in each group. For example, group “P1” might have 5 keywords, group “P2” might contain 10 keywords, group “P3” might contain 17 keywords, group “P4” might include 10 keywords, and so on.

In this way, the keyword search illustrated in FIG. 6 generally operates so that keywords are extracted from the received electronic information, then the keywords can be categorized according to priority ranking B (i.e., the second priority ranking) in accordance with step (f) of FIG. 2. Note that while the flow of the keysearch method step is such that information processing starts with keyword group “P1,” all of the steps 1 through 7 need not necessarily be executed (i.e., execution need not be performed all the way to the final P_{N}). In other words, it is within the scope of the present invention to perform a partial keyword search wherein only some of the keyword groups are used and others are excluded. With respect to the decision regarding whether to carry out a complete determination of priority ranking based upon a complete keyword search or whether to carry out priority ranking based upon a partial keyword search, various situations can be imagined depending on the intentions of the person(s), (i.e., managerial staff or the like), using the present information processing method and system.

Overall Ranking Determination Comment Component

Comment attachment component 40 shown in FIG. 3 (a) decides final priority ranking in accordance with the priority ranking of the keywords extracted from the received electronic information as a result of the search for keywords performed by keyword analyzing component 30 that resulted in priority ranked extracted keywords saved in extracted keyword database 34 (or in component databases 34a and/or 34b of the extracted keyword database). In other words, because each keyword group had its own priority ranking so that all keywords in a given keyword group share the same priority ranking, the natural result of the keyword search performed in accordance with the process illustrated in FIG. 6 is to generate information regarding the saved extracted keywords that is priority ranked in accordance with keyword priority ranking B. The information produced as a result of keyword extraction by keyword analyzing component 30 is priority ranked by keyword group in accordance with keyword priority ranking B (i.e., the second priority ranking) while incorporating priority-ranked A information (i.e., the first priority ranking) generated as a result of the processing of received unprocessed electronic information provided by signal receiving component 20 and saved in database 25.

FIG. 7 shows in the portion thereof indicated by the broken line a block diagram schematically illustrating the interior of priority ranking determination/comment attachment component 40. This block diagram also outlines a calculation method that utilizes keyword preferred groups, for example, keyword preferred group B, while reflecting information concerning priority ranking A based on number of received transmissions as will be described as follows. Priority ranking determination/comment attachment component 40 comprises calculating components 41a through 41c and sorting component 42. Component 40 is connected to receive input from a component databases 34a, 34b, 34c of the extracted keyword database 34 and from the priority ranking determining component 24.

The following example is provided to illustrate various features in accordance with the present invention; however, those skilled in the art would realize that the present example facilitates understanding of the invention and is non-limiting. Imagine an assignment of weights for priority ranking (A) which is based on number of received transmissions, for example, such that

| | |
|---|---|
| Most important (MI) | 8 |
| Important (I) | 4 |
| Other (N) | 1 |

and an assignment of weights for keyword priority ranking (B), for example, wherein

| | |
|---|---|
| Most preferred group (P1) | 30 |
| Preferred group (P2) | 6 |
| Others group (P3) | 2. |

Those skilled in the art would realize that the assignments of weights can be non-linear or linear without departing from the scope of the present invention.

By calculating the (A)×(B) matrix, the following

| | | |
|---|---|---|
| P1 × MI = 240, | P1 × I = 120, | P1 × N = 30, |
| P2 × MI = 48, | P2 × I = 24, | P2 × N = 6, |
| P3 × MI = 16, | P3 × I = 8, | P3 × N = 2, |

may be calculated.

The results of the above exemplary calculation may be listed in descending numerical order as 240, 120, 48, 30, 24, 16, 8, 6, and 2. The priority ranking is such that the final priority ranking (i.e., the overall ranking) for the situation where the number of received transmissions is extremely high (in this example, when 8 or above) has a greater ranking than the situation where the keyword belongs to the most preferred group (MI=30) but the number of received transmissions is extremely low (in this example, when 1 or less). In other words, P2×M1=48 while P1×N=30 so that the matrix element P2×M1 has a higher priority ranking than the matrix element P1×N.

Therefore, by optimizing the assignment of weights for respective groups, which affects the values of the various matrix elements, it is possible to cause the intentions and goals of the operators (i.e., the managers) of the present system to be reflected thereby.

In addition, comments in alphanumeric form can be prepared corresponding by magnitude to the results of calculation; e.g., sample comments such as follows might include:

Highest magnitude was 240, therefore assigned highest-level danger signal; comment: “requires immediate response.” For example, item to be reviewed by company president.

Second highest magnitude was 120, therefore assigned plain danger signal; comment: “requires immediate response.” For example, item to be reviewed by company president.

Third highest magnitude was 48, therefore assigned less critical danger signal; comment: “requires immediate response.” For example, customer dissatisfaction level is extremely high, so item to be reviewed by responsible sales executive.

Fourth highest magnitude was 30, therefore assigned even less critical danger signal; comment: “requires immediate response.” For example, item to be reviewed by and responded to by senior managing director.

Lowest magnitude was 24, therefore assigned high probability of developing into danger signal; comment: “requires prompt response.” For example, item to be reviewed by head of sales headquarters.

Those skilled in the art would recognize that other ranked comments and the like are imaginable without departing from the scope and spirit of the present invention.

Furthermore, comments corresponding to priority ranking, keyword content, number of received transmissions, and the like can be prepared in advance before these comments are sent and ordered so as to be grouped by overall ranking to report component 50, which is described below. In this manner, comment(s) based on priority score (i.e., magnitude) are generated first so that the importance of received information is conveyed in direct fashion with the keyword(s) themselves, and the comment(s) appropriate to those keyword(s), are included in the report that follows.

Report Component

Report component 50 receives input information from comment attachment component 40 and organizes into report format 1) priority ranking(s), 2) keyword(s), 3) number(s) of received transmissions, and 4) the attached comment(s) along with the received electronic information transmitted from comment attachment component 40. Report component 50 then organizes this information into one or more forms respectively suited for one or more previously established destinations, (e.g., top management, executive staff, and customers), and automatically sends these one or more forms, which can be collectively referred to as “reports,” to the one or more previously established destinations. Prior to automatic sending, content of the automatically created reports may be confirmed by a user or a co-user of the system, and in addition, comment(s) from experts and the like may be attached to the reports before sending.

A Method Embodiment in Accordance with the Invention

An exemplary management information processing method employing the system described above is described below.

First Working Crisis Examples

Corporations presently receive communications expressing dissatisfaction, requests for improvement, and other such complaint-type information in connection with products. Corporations treat such information as crisis control information, and each business day corporations devote a lot of time and effort addressing and responding to such crisis control information.

What most corporations actually do is to establish a customer support center, or other such contact point, that communicates with the different corporate departments responsible for responding to a particular type of crisis control information depending upon content (i.e., a complaint or the like) Then, either the customer support center or the responsible corporate department responds individually to each one of the complaints/desires/etc. in connection with respective products.

However, the number of products provided by a corporation may be voluminous, thereby making it is extremely difficult to constantly acquire, and timely respond to, appropriate crisis control information amidst the ever changing circumstances marked by the ongoing globalization of the marketplace. Even where the crisis control information, and the measures to be adopted in response thereto, are themselves straightforward, there are many cases in which a delay in response of even one day will result in the loss of a great deal of money to the corporation in question.

Imagine, for example, that the initial lot of a new product manufactured by a certain manufacturer contains a serious life-threatening defect, and that those products have unfortunately been distributed on the market. Clearly, before the actual occurrence of harm, or while the number of instances of harm is still small, the manufacturer would like to immediately recall the product, or adopt other such measures, as will limit the expansion of harm and corporate liability.

A prompt response is to be expected from the standpoint of humanitarianism, and the speed with which the corporation responds to this crisis may very well affect the continued existence of the corporation itself for a long time to come, such as in terms of damage to the corporate image, loss of credibility, claims for damages arising under product liability law (“PL law”), or the like, and so forth.

Or, for example, where a software bug is discovered in a new computer product, there are occasionally cases where operating losses arising due to the response thereto reach several tens of billions of yen per year. In such a case, it is conceivable that had the bug been discovered earlier and measures adopted in response thereto put into effect much earlier, the damage caused by the defective software might have been much, much smaller.

Or, for example, imagine that at a certain time a certain product is extremely well received, so that a shortage of supply occurs on the market. Or, for example, a similar situation could occur where information is received that a large-volume customer will purchase a large quantity of that particular product. In these mismatched supply and demand situations, unless such critical information is quickly obtained and a response thereto promptly adopted, it may very well be that the opportunity to optimally sell the hit product will be lost.

On the other hand, varied and diverse information that discusses a particular product may originate from customers, media organizations, consumer groups, and the like, and is dispersed on the market by way of various media such as television, radio, periodicals, the Internet, and so forth. In particular, because various electronic information presently flies back and forth instantaneously by way of the Internet, corporations obtain voluminous amounts of varied and diverse electronic information. Contained within such information, there is sometimes content representing crisis control information, or other such management information, which the corporation that manufactured a particular product should be constantly trying to acquire.

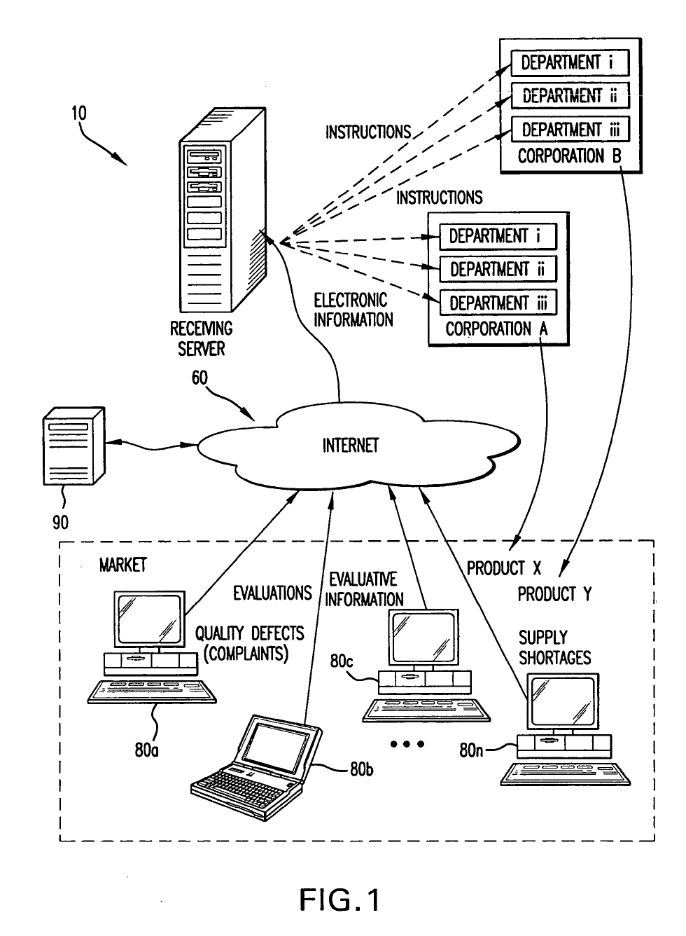

FIG. 1 outlines a working example of a management information processing method in accordance with the present invention. Furthermore, FIG. 2 outlines the processing steps in a management information processing method in accordance with the present invention. When Corporation A and Corporation B distribute one or more products on a market, within that market various types of information, (i.e., performance evaluations, pricing information, complaints regarding quality defects or the like, shortage of supply, and so forth), with respect to those products take the form of electronic information, and are dispersed by way of electrical communication lines belonging to the Internet, or the like. Such information is conventionally propagated without regard to content, importance level, or the like, so that the valuable information is mixed in with and obscured by the worthless information. Because it is, after all, the person receiving the information who determines what is important, the way in which such information is received, and the response taken with respect to the information, will be different for different recipients.

As shown in FIG. 1, receiving server 10 is connected to an electrical communication line belonging to the Internet, or the like. Varied, diverse, and vast amounts of electronic information, the nature of which may include product evaluations, complaints regarding quality defects or the like, pricing information, and shortages of supply information, is sent from one or more terminal devices 80 (80a, . . . , 80n) located throughout the market and connected to receiving server 10 by way of the Internet. Thus, the first step in the management information processing method embodiment in accordance with the present invention as shown in FIG. 2 is for the server 10 to receive the varied, diverse and vast amounts of electronic information from one or more senders (i.e., terminal devices) connected to the Internet, or alternately via some other computer network (step a).

Note that it may also be the case that information originating from information terminal 80 is saved at an information server 90, or the like, so that the saved information can be processed at a later time. Receiving server 10 may proactively access information server 90 to receive previously stored electronic information therefrom without departing from the scope of the present invention.

Extremely important in determining the importance level of information is the question: What is the source of the electronic information? In this sense, a determination or analysis of source (i.e., sender information, etc., in the case of electronic mail) is important.

Whether or not the electronic information is from a known sender, or a new sender, is therefore determined at signal receiving component 20. More specifically, for example, where the source of the electronic information is electronic mail, the sender is determined (i.e., identified) by investigating to determine the domain name, and so forth, of the sender's electronic mail address.

Receiving server 10 determines or identifies the sender by comparing presently obtained sender information from the received electronic information with previously registered sender information (step b). Next, the number of transmissions received from the same sender is determined (step c), and priority ranking of the sender is determined based on the results of the number of transmissions received by a particular sender (step d). Of course, each particular sender can also be given a weight so that one particular sender's electronic information may be given a greater weight than that of another particular sender without departing from the scope of the present invention.

In this way, electronic information which has passed through signal receiving component 20, and which is in a state such that it is ranked according to priority ranking A (i.e., the first priority ranking), is sent to keyword analyzing component 30, which represents the next stage of information processing.

At keyword analyzing component 30, a keyword search is performed during which extraction of one or more previously registered keywords from the received electronic information content is carried out (step e). Based on the results of the keyword search, priority ranking B (i.e., second priority ranking) is carried out so as to correspond to the importance levels of extracted keywords (step f).

Keywords are such that keywords and priority ranking(s) are decided by the corporation management as part of the corporate strategy for each product. For example, subject matter for keywords involving human lives (i.e., fires, accidents resulting in injury or death, etc.) could be assigned a most preferred P1 priority ranking, whereas antisocial subject matter keywords (i.e., pollution-related issues, disinformation, etc.) could be assigned a preferred P2 priority ranking, whereas normal keyword subject matter could be assigned a P3 priority ranking, reference keyword subject matter could be assigned a Pn (e.g., n=4) priority ranking, and so forth, wherein these prioritized keywords having been registered in advance in the server 10.

FIG. 3 (b) illustrates an exemplary keyword composition table manifesting one example of keyword priority ranking B (i.e., second priority ranking). Those skilled in the art would appreciate that the keyword composition table shown in FIG. 3(b) is a non-limiting example and that other such tables could be created and used in the present invention.

Keywords are saved such that they are categorized not only according to importance level, but keywords are also categorized as either shared keywords indicating universal content, or as individual keywords indicating individual content. As demonstrated by this table keyword composition table, one or more keyword databases exist such that selected keywords are previously registered or saved therein. In the example given in FIG. 3(b), the keywords are categorized into four groups as represented by the most preferred keyword group P1, the preferred keyword group P2, the normal keyword group P3, and “others” keyword group Pn (n=4). Note that n may be increased and the number of categories increased.

In accordance with these categories, the most preferred keywords (a1, a2, . . . , a_{N}) are saved in the most preferred keyword group P1, the preferred keywords (b1, 2 . . . , b_{N}) are saved in the preferred keyword group P2, the normal keywords (c1, c2, . . . , c_{N}) are saved in the normal keyword group P3, and the reference keywords (d1, d2, . . . , d_{N}) are saved in the reference keyword group Pn.

Keyword groups P1 through Pn are respectively assigned scores, for example, one assignment of scores could be such that P1=30, P2=6, P3=2, and Pn=1.

Keywords are further categorized by distinguishing between shared items indicating universal content and individual, specific items indicating individual, specific content. The advantages of dividing keywords into shared keywords and individual keywords are explained as follows.

(1) Maintenance/Improvement of System Quality

The present system can accommodate crisis control, information control, and information analysis in the context of corporate, administrative, and/or any other situation requiring timely decision making. Looking at this from a different point of view, “public” determinative criteria are adopted for common information so that shared keywords are assembled reflecting keywords of comparatively high universality, (i.e., at a minimum, those keywords involving social justice, social rules, social truisms, and so forth), which form the basis for the public determinative criteria. On the other hand, individual keywords are assembled so that keywords reflecting “private” determinative criteria take into consideration corporate, administrative, or other such private circumstances, which form the basis for private determinative criteria.

Furthermore, keywords initially assigned to the individual keyword database may be converted to shared keywords if a particular keyword evolves a higher universality, thereby permitting fuller utilization of shared keywords. Consequently, by preparing two types of keyword groups (i.e., shared groups and individual groups), it is possible to maintain and improve the quality of keywords, which represents a most important component of the information processing system.

(2) Improved Efficiency with Respect to Time for Verification/Comparison with Received Information

When verifying and/or comparing received electronic information with one or more keyword databases, the method efficiently carries out verification and/or comparison for the presence of one or more keywords using the shared database(s) for verification and/or comparison with the received information. Having carried out a basic shared keyword check in a short period of time, the method subsequently carries out verification and/or comparison for the presence of one or more keywords using the individual database(s) for verification and/or comparison with the received information. In this two step manner, it is possible to increase time efficiency of verification and/or comparison of the received information with important shared and individual keywords. Furthermore, by dividing database(s) into two types (i.e., shared and individual), it is possible to efficiently reduce access times with respect to the one or more databases.

(3) Improved Efficiency of Keyword Database Development

By dividing keyword databases into two types, shared and individual, great savings can be realized in development man-hours and maintenance man-hours, because once a keyword database has been developed it is likely that only partial revisions will be needed in the future as corporate goals fluctuate. Accordingly, there is the advantage that the user of the system need only consider mainly the man-hours required for the development and maintenance of the individual keyword database. The shared keyword database is unlikely to require future revision because the keywords are universal and are less likely to change as corporate goals fluctuate.

Returning to the description of the first crises examples mentioned above, the present information processing system next calculates an overall priority ranking in accordance with sender ranking and keyword priority ranking, and creates comments that are attached to the received electronic information (step g). Such comments generated in accordance with sender ranking and keyword priority ranking may be registered in advance within the receiving server 10, or may be created automatically from the keywords, or the like. In either case, it is preferred that such generated comments contain instructions that will lead various recipients to immediate actions. Lastly, receiving server 10 creates one or more reports utilizing the generated comments, and delivers instructions to appropriate corporate departmental organizations, authorities, and etcetera.

Receiving server 10 receives varied, diverse, and vast amounts of information through the Internet, or other such electrical communication line(s), selects only necessary information based on previously established sender information and/or keyword information, and dispatches previously prepared comment(s), as well as report(s), to the proper corporate departmental organizations/authorities (step h).

Note that even where comments are themselves extremely simple, a comment soliciting an immediate response or action is extremely significant from a managerial standpoint. In this regard, comment content should be sufficiently specific and detailed in a succinct manner so as to lead to specific action. For example, specific comments may be of the sort such as “Delay in response of one day or more will result in a loss of 1 billion yen/month. Please respond immediately.”

In this way, all electronic information from the market is acquired via the Internet, or computer network, by the single contact point represented by receiving server 10, and respective corporate departmental organizations and the like can promptly acquire comments indicating information necessary for making management decisions within the scope of operations of the departmental organization in question, as well as suggesting measures in response to critical information content.

Because server 10 provides a single contact point, the entity managing this server may enter into a contract with the corporation, or the like, which wishes to receive a provision of processed information. Under these circumstances, the server 10 managed by the contracting entity becomes the contact point for electronic information, and acquires varied, diverse, and vast amounts of electronic information, and may be located off-site from the contracting corporation. A usage method is imagined within the scope of the present invention in which priority ranking is assigned to received information in accordance with received information content, and one or more reports containing appropriate comment(s) corresponding to that content is or are created and dispatched to a corporation, or the like.

For example, where a defective product tends to cause fires, or where food products have contaminants mixed therein, etc., etc., and it has been discovered that these particular products have been on sale during a specific period in a specific region, there exists an interest in adopting measures for preventing the occurrence of like events. The present invention creates report(s) that would be received by the proper decision making department or authority, and to these reports are attached appropriate comment(s) urging that the manufacture and sale of these hazardous products be stopped until the defective cause, or source of contamination, can be identified, or the reports may urge the adoption of other measures to address the product liability problem.

Note that although Corporation A and B have been presented as examples of manufacturing industry entities, the present invention is not limited to these examples. In fact, those skilled in the art of information processing would realize that the present system and method for information processing can be applied to any industry, such as the financial industry, the insurance industry, and other such service industries, as well as manufacturing industries, and all other types of industry.

Thus, by applying the information processing method in accordance with the present invention to corporate managerial crisis control, or other such crisis control situations, and by assigning priority ranking(s) in accordance with importance level(s) to necessary information garnered from Internet information, electronic mail, and/or other such electronic information, it is possible for critical information to be obtained efficiently from vast amounts of information without the need to read unwanted, superfluous information, and it is possible for appropriate comments to be imparted or attached to the critical information in accordance with the importance level(s) of various information so as to permit the prompt execution of the necessary managerial action or response.

In accordance with the information processing method of the present invention, after establishing system settings, all receiving, comparison, analysis, and reporting operations are carried out automatically so that the system is operating in a self-sufficient fashion. The series of operations or steps of the method are therefore carried out automatically without the need for any special procedure on the part of the user, thereby permitting the attachment and the sending of comments representing newly processed information generated as a result of the operations.

A user of the present system makes use of the information processing system, which figuratively is a “black box,” so to speak, to the user, because the system automatically permits the constant monitoring of customer wishes and complaints, and permits salient points within the content of the information representing customer wishes and complaints to be grasped, and even generates proposals urging immediate appropriate action. In other words, the user will now have “an electronic watchman” (i.e., e-Secretary), so to speak, to keep a lookout for critical information flowing through the Internet or a computer network.

Moreover, whereas a method for setting perusal frequency level, evaluation level, a priority level calculation method, and so forth, are central to the method disclosed by the Japanese '557 Application, in the information processing method in accordance with the present invention perusal level is not set, but is automatically calculated—and importance level of received information is determined—based on the number of received transmissions of electronic information, followed by a search for keywords contained within the content of the received electronic information. Therefore, the technical idea and steps of the present invention are different from the information processing method described by the Japanese '557 Application.

Furthermore, whereas priority level in the method of the Japanese '557 Application reference is calculated from perusal level and evaluation level, in the present invention priority level is an item to be “previously established” based on certain subjective or selected evaluative criteria, such as managerial judgment or the like, and is not obtained in an after-the-fact fashion through “calculation.”

Second Working Crisis Example

The receiving and information processing system described above may also be applied to a crime-prevention system for use by police, a security company, other law enforcement agency, or the like. By modifying the first working crisis example, it can be applied to law enforcement applications. In this context of the second working crisis example, the corporation is replaced with the police and/or a security company, consumers in the marketplace are replaced with the citizens of the community or the like, the product complaints and opinions received by corporations from consumers is replaced with provisions of information, or grievances, and/or wishes received by police or the like originating from community citizens or the like, and appropriately established keywords are selected that would reflect the goals of the command structure of the law enforcement agency. In this second working crisis example, the receiving server 10 may be modified to carry out analysis of content from electronic information from the community, and to send to police or the like appropriate instructions (i.e., comment-carrying information) such as will permit increased law enforcement effectiveness with respect to improvement in response to criminal activity and/or crime prevention.

Third Working Crisis Example

The information receiving and processing system described above may also be applied to a system for facilitating policy decisions, or the like, by a government agency or the like. For example, the bureaucrats at a government agency might register keywords in connection with particular decisions, policies, and/or the like at a database of a receiving server 10, thereby permitting a keyword analysis of electronic information containing opinions, and so forth, received from the citizenry, or the like, and thereby permitting confirmation of the response from citizens during a particular period (i.e., short-term period)

In accordance with the management information processing system and method of the present invention, a management information processing system and method are provided that selects only critical information, such as will benefit a specific user (i.e., corporate management official, law enforcement official, or government bureaucrat and the like), from among varied, diverse, and vast amounts of electronic information obtainable by way of electrical communication lines belonging to the Internet, computer networks, or the like, and that gives immediate instruction as to what appropriate response is needed. The present invention sifts critical information of high reliability from unimportant information to provide processed information that is useful to corporate management, law enforcement commands, government bureaucrats and the like.

While the present invention has been described with reference to certain preferred embodiments, one of ordinary skill in the art will recognize that additions, deletions, substitutions, modifications and improvements can be made while remaining within the spirit and scope of the present invention as defined by the appended claims.

What is claimed is:

1. In a management information processing system wherein one or more receiving servers receive electronic information originating from a plurality of senders, select specific information included within the electronic information received, create one or more reports containing one or more comments soliciting one or more actions corresponding to the content of the electronic information, and sending the one or more reports to one or more previously established destinations, a management information processing method comprises the steps of:
a) at least one step wherein electronic information is received by the one or more receiving servers;
b) at least one step wherein one or more senders of electronic information are identified by the one or more receiving servers;
c) at least one step wherein the number of received transmissions deemed to have been received from each sender is determined by the one or more receiving servers;
d) at least one step wherein a first priority ranking is decided by the one or more receiving servers based on the number of transmissions received from each sender;
e) at least one search step wherein one or more groups of keywords previously assigned information-related importance levels are used in keyword searching by the one or more receiving servers for one or more keywords contained within the electronic information received at the receiving step;
f) at least one step wherein a second priority ranking is decided by the one or more receiving servers based on respective importance levels assigned to at least one keyword extracted as a result of the keyword search of the received information;
g) at least one step wherein one or more comments are created by the one or more receiving servers based on the first and second priority rankings; and
h) at least one step wherein one or more reports are generated by the one or more receiving servers, wherein each report comprises information corresponding to the plurality of senders, the numbers of transmissions received, and attached comments.

2. A management information processing method according to claim 1, wherein at step (e), the one or more groups of keywords comprise one or more shared keywords indicating universal items and one or more individual keywords indicating individual items, and the attached comments comprise first comments previously established to correspond to the one or more shared keywords and second comments previously established to correspond to the one or more individual keywords.

3. A management information processing method according to claim 1, further comprising at least one step (i) wherein a portion of keyword data contained within one or more databases in which one or more individual keywords are saved is moved to one or more databases in which one or more shared keywords are saved.

4. A management information processing method according to claim 1, wherein in step (e), during keyword searching a verification or a comparison of received electronic information with one or more keyword databases is performed, wherein a first investigation is carried out to ascertain whether at least one keyword saved in a shared database is present in the received electronic information, followed by a second investigation carried out to ascertain whether at least one keyword saved in an individual keyword database is present in the received electronic information.

5. A keyword determination method for determining whether received information comprises one or more words that match one or more keywords registered within any one of a plurality of keyword databases grouped so as to be numbered from a 1st through an nth, where n is a natural number, wherein the method comprises the following steps:
one or more steps wherein each word making up text contained within received information is sequentially compared with one or more keywords belonging to the plurality of grouped keyword databases; and
one or more steps wherein, when there is a matching word, a corresponding Y flag is set and every occurrence of that word is saved in an extracted keyword database, and when there is no match for a particular keyword, a corresponding N flag is set and no word corresponding to that particular keyword is saved to the extracted keyword database.

6. A information processing system connected to receive electronic information, wherein the system includes at least one receiving server, and the at least one receiving server comprises:
a signal receiving component connected to receive the electronic information, wherein the receiving component determines a first priority ranking of the received electronic information;
a keyword analyzing component connected to receive the first priority ranked electronic information and the received electronic information from the receiving component, wherein the keyword analyzing component performs a keyword search of the received electronic information and determines a second priority ranking of the received electronic information based on keywords extracted from the received electronic information;
a comment component connected to receive the second priority ranked electronic information and the received electronic information from the keyword analyzing component, wherein the comment component calculates a final priority ranking and generates one or more comments based upon the final priority ranking; and
a report component connected to receive the received electronic information, the final priority ranked information and the one or more generated comments, wherein the report component generates one or more reports incorporating the received electronic information, the final priority ranked information, and the one or more generated comments.

7. An information processing system as recited in claim 6, wherein the system is connected to receive electronic information from either the Internet or a computer network system.

8. An information processing system as recited in claim 6, wherein the signal receiving component comprises:
a virus checking component that checks the received electronic information for one or more computer viruses;
a sender determining component connected to receive the received electronic information from the virus checking component, wherein the sender determining component determines the identity of the sender of the received electronic information; and
a transmissions determining component connected to receive the received electronic information from the virus checking component, wherein the transmissions determining component determines the number of transmissions received from each sender.

9. An information processing system as recited in claim 6, wherein the signal receiving component comprises:
a sender determining component connected to receive the received electronic information, wherein the sender determining component determines the identity of the sender of the received electronic information; and
a transmissions determining component connected to receive the received electronic information, wherein the transmissions determining component determines the number of transmissions received from each sender.

10. An information processing system as recited in claim 9, wherein the signal receiving component further comprises a priority ranking component connected to receive input from both the sender determining component and the transmission determining component, wherein the priority ranking component performs the first priority ranking of the received electronic information by utilizing both the identity of and the corresponding number of transmissions received by each sender.

11. An information processing system as recited in claim 6, wherein the keyword analyzing component comprises a keyword determining component connected to access one or more keyword databases and connected to send output to at least one keyword extracting database, wherein the keyword determining component compares individual words from the received electronic information to each keyword stored in the one or more keyword databases and determines when there is a match so that when there is a match the keyword determining component sets a Y flag and the matched word is saved in the at least one keyword extracting database.

12. An information processing system as recited in claim 6, wherein the comment component comprises a priority ranking determination/comment attachment component that includes a plurality of calculating components and a sorting component, wherein the priority ranking component utilizes the first priority ranking and the second priority ranking to calculate a matrix and assigns the final priority ranking based upon the relative magnitudes of each matrix element.

13. An information processing system as recited in claim 6, wherein the report component organizes the first priority ranking, the second priority ranking, the extracted keywords, the number of received transmissions, the one or more comments, and the received electronic information into a report format, then sends one or more reports to a predetermined destination.

14. A method of processing management information comprising the steps of:
receiving electronic information into a receiving server;
identifying a sender corresponding to each transmission contained within the received electronic information;
determining the number of received transmissions contained within the received electronic information; and
performing a first priority ranking of the received electronic information based upon sender criteria and the number of received transmissions.

15. A method as recited in claim 14, wherein the received electronic information is checked for one or more computer viruses when received into the server.

16. A method as recited in claim 14, further comprising the steps of:
performing a keyword search on the received electronic information, wherein the keyword search includes comparing a first keyword stored in a keyword database to each word in the received electronic information and setting a Y flag when there is a match and setting a N flag when there is no match.

17. A method as recited in claim 16, wherein each time the Y flag is set, the word matching the keyword is saved in an extracted keyword database.

18. A method as recited in claim 17, further comprising the steps of:
performing a second priority ranking of the received electronic information based upon one or more extracted keywords; and
performing a final priority ranking of the received electronic information based upon a matrix calculation utilizing the first priority ranking and the second priority ranking.

19. A method as recited in claim 18, further comprising the step of:
generating one or more comments corresponding to the one or more previously extracted keywords and the final priority ranking and attaching these one or more comments to the received electronic information.

20. A method as recited in claim 19, further comprising the step of:
organizing the first priority ranking, the second priority ranking, the extracted keywords, the number of received transmissions, the one or more comments, and the received electronic information into a report format, then sending one or more reports to a predetermined destination.
